(19) United States
(12) Patent Application Publication
(10) Pub. No.: US 2016/0108657 A1
(43) Pub. Date: Apr. 21, 2016

(54) SYSTEM AND METHOD OF MALFUNCTION DIAGNOSIS OF MIDDLE DOOR OR STEP FOR VEHICLE

(71) Applicants: HYUNDAI MOTOR COMPANY, Seoul (KR); Kia Motors Corporation, Seoul (KR)

(72) Inventor: Hwa Yong JANG, Hwaseong-si (KR)

(21) Appl. No.: 14/731,114

(22) Filed: Jun. 4, 2015

(30) Foreign Application Priority Data
Oct. 20, 2014 (KR) 10-2014-0142063

(51) Int. Cl. E05F 15/40; B60W 50/14

(52) U.S. Cl. CPC E05F 15/40; B60W 50/14; B60W 2510/30; B60W 2710/0605; B60W 2050/146

(57) ABSTRACT

A malfunction diagnosis method of a middle door or a step for a vehicle may include: a first receiving step receiving a first operating signal from the middle door or the step of the vehicle; a first diagnosis step of diagnosing whether the middle door or the step is in a failure state based on the first operating signal; a second receiving step of receiving a second operating signal from the middle door or the step of the vehicle; a second diagnosis step of diagnosing whether the middle door or the step is in a failure state based on the second operating signal; determining whether an engine is starting if the first and second diagnosing steps indicate the middle door or the step is in the failure state; and setting an interlock on an accelerator pedal if it is determined that the engine is starting.

### CROSS-REFERENCE TO RELATED APPLICATION

This application claims the benefit of priority to Korean Patent Application No. 10-2014-0142063 filed in the Korean Intellectual Property Office on Oct. 20, 2014, the entire contents of which are incorporated herein by reference.

### TECHNICAL FIELD

The present disclosure relates to a system an method of malfunction diagnosis of a middle door or a step of a vehicle. More particularly, the present disclosure relates to a system and method of malfunction diagnosis of a middle door or a step of a vehicle that enhances malfunction diagnosis by performing malfunction diagnosis in an extra controller as well as an ECU.

### BACKGROUND

Generally, a middle door or a step is provided in a heavy vehicle or a recreation vehicle for boarding convenience of an occupant.

For these vehicles, the vehicle cannot be operated when the middle door is open or the step is protruded according to relevant regulations, for example, ECE R 107.

Thus, if the middle door is open or the step is protruded because the middle door or the step is in a failure state, an engine control unit (ECU) detects a malfunction of the middle door or the step and sets an interlock on an accelerator pedal. That is, ECU receives a voltage signal from an operation device of the middle door or the step and diagnoses whether the middle door or the step is in the failure state.

However, since only the ECU diagnoses the malfunction according to a conventional art, the malfunction of the middle door or the step cannot be diagnosed accurately when a sudden disorder of CAN communication connected to the ECU is generated.

The above information disclosed in this Background section is only for enhancement of understanding of the background of embodiments of the invention and therefore it may contain information that does not form the prior art that is already known in this country to a person of ordinary skill in the art.

### SUMMARY

An exemplary embodiment of the present invention provides a malfunction diagnosis method of a middle door or a step for a vehicle. The method may include: a first receiving step of receiving a first an operating signal from the middle door or the step of the vehicle; a first diagnosis step of diagnosing whether the middle door or the step is in a failure state based on the first operating signal; a second receiving step of receiving a second operating signal from the middle door or the step of the vehicle; a second diagnosis step of diagnosing whether the middle door or the step is in a failure state based on the second operating signal; determining whether an engine is starting if the first and the second diagnosis steps indicate that the middle door or the step is in the failure state; and setting an interlock on an accelerator pedal if it is determined that the engine is starting.

In certain embodiments, the malfunction diagnosis method may further include displaying a warning to a driver if the interlock on the accelerator pedal is set.

In certain embodiments, the first operating signal may be a voltage value that changes in accordance with the operation of the middle door or the step, and

the second operating signal may be data input by CAN communication for determining whether the middle door or the step operates.

In certain embodiments, the first diagnosis step may include determining that the middle door or the step is in the failure state when the voltage value has a change rate that is out of a normal range, and

the second diagnosis step may include determining that the middle door or the step is in the failure state when the data inputted by the CAN communication represents the failure state.

In certain embodiments, the first receiving and diagnosis steps may be performed by a first controller, and the second receiving and diagnosis steps may be performed by a second controller.

In certain embodiments, the first controller may be configured to control the middle door or the step of the vehicle, and the second controller may be configured to control the engine.

Another embodiment provides a malfunction diagnosis system in a vehicle. The system may include an engine, a middle door or a step of the vehicle, an accelerator pedal comprising an interlock; and one or more controllers configured to perform at least one of the following steps:

a first receiving step of receiving a first operating signal from the middle door or the step of the vehicle;

a first diagnosis step of diagnosing whether the middle door or the step is in a failure state based on the first operating signal;

a second receiving step of receiving a second operating signal from the middle door or the step of the vehicle;

a second diagnosis step of diagnosing whether the middle door or the step is in a failure state based on the second operating signal;

determining whether an engine is starting if the first and second diagnosis steps indicate that the middle door or the step is in the failure state; and

setting an interlock on an accelerator pedal if it is determined that the engine is starting. The one or more controllers, in combination, may be configured to perform all of the steps.

In certain embodiments, the system may further include a display, and the one or more controllers may be configured to display a warning to a driver if the interlock on the accelerator pedal is set.

In certain embodiments, the first operating signal may be a voltage value that changes in accordance with the operation of the middle door or the step, and the second operating signal is data input by CAN communication for determining whether the middle door or the step operates.

Another embodiment may provide a non-transitory computer readable storage medium containing a computer program configured to cause the following to occur when read and processed by a computer system:

a first receiving step of receiving a first operating signal from the middle door or the step of the vehicle; a first diagnosis step of diagnosing whether the middle door or the step is in a failure state based on the first operating signal; a second receiving step of receiving a second operating signal from the middle door or the step of the vehicle; a second diagnosis step of diagnosing whether the middle door or the step is in a failure state based on the second operating signal; determining whether an engine is starting if the first and second diagnosis steps indicate that the middle door or the step is in the failure state; and setting an interlock on an accelerator pedal if it is determined that the engine is starting.

According to certain exemplary embodiments of the present invention, robustness and reliability of the malfunction diagnosis can be secured by simultaneously performing malfunction diagnosis in an extra controller as well as an ECU.

In addition, an interlock on an accelerator pedal may be accurately set due to a correct malfunction diagnosis, so an occupant may board the vehicle safely while meeting regulations.

### BRIEF DESCRIPTION OF THE DRAWINGS

FIG. 1 is a block diagram illustrating a system to which a malfunction diagnosis method of a middle door or a step of a vehicle according to an exemplary embodiment of the present invention is applied.

FIG. 2 is a flowchart illustrating a malfunction diagnosis method of a middle door or a step for a vehicle according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention.

Throughout this specification and the claims which follow, unless explicitly described to the contrary, the word “comprise” and variations such as “comprises” or “comprising” will be understood to imply the inclusion of stated elements but not the exclusion of any other elements.

Like reference numerals designate like elements throughout the specification.

In certain embodiments, the control logic of the present invention may be embodied as non-transitory computer readable media on a computer readable medium containing executable program instructions executed by a processor, a controller, or the like. Examples of computer readable media include, but are not limited to, ROM, RAM, compact disc (CD)-ROMs, magnetic tapes, floppy disks, flash drives, smart cards, and optical data storage devices. The computer readable recording medium can also be distributed in network coupled computer systems so that the computer readable media is stored and executed in a distributed fashion, e.g., by a telematics server or a controller area network (CAN).

An exemplary embodiment of the present invention will hereinafter be described in detail with reference to the accompanying drawings.

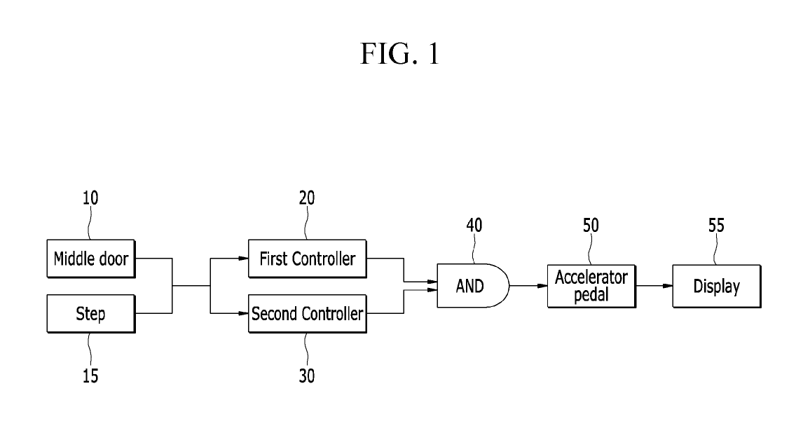

FIG. 1 is a block diagram illustrating a system to which a malfunction diagnosis method of a middle door or a step for a vehicle according to an exemplary embodiment of the present invention is applied.

As shown in FIG. 1, a system to which a malfunction diagnosis method of a middle door or a step for a vehicle according to an exemplary embodiment of the present invention is applied may include a middle door 10 or a step 15, a first controller 20, a second controller 30, and an accelerator pedal 50. Certain embodiments further include a display 55. In certain embodiments, the system may include an AND gate 40.

The malfunction diagnosis system of a middle door or a step for a vehicle according to an exemplary embodiment of the present invention may include at least one of the middle door 10 or the step 15 to diagnose malfunction of the middle door 10 or the step 15 on each or simultaneously.

In addition, in an exemplary embodiment of the present invention, the first controller 20 may control the middle door 10 or the step 15, and the second controller 30 may control an engine, but it is not limited thereto. The first controller 20 and the second controller 30 may be independently configured, and in some cases, the first controller 20 may be configured to include the second controller 30 or the second controller 30 may be configured to include the first controller 20 in consideration of a design aspect. Thus, in certain embodiments, a single controller may perform the functions of both first controller 20 and second controller 30. On the other hand, in certain embodiments, the system may include more than two controllers.

In certain embodiments, the first controller 20 and the second controller 30 may be implemented as at least one microprocessor that is operated by a predetermined program, and the predetermined program may be programmed in order to perform each step of a malfunction diagnosis method of a middle door or a step for a vehicle according to an exemplary embodiment of the present invention.

In embodiments including a middle door 10, the middle door 10 is generally mounted on a heavy vehicle or a recreation vehicle, and may be used as an aisle for boarding. In certain embodiments, middle door 10 is connected to an apparatus for opening and closing including a motor and a plurality of arms, and may include the first controller 20 for control thereof.

Thus, in certain embodiments, the apparatus for opening and closing rotates the motor and a plurality of arms according to a signal from the first controller 20 which results in opening and closing operations of the middle door 10.

In certain embodiments, the step 15 is integrally mounted at the middle door 10 or separately mounted from the middle door 10 to help an occupant to board. That is, the step 15 has a step structure, so an occupant can step on the step 15 to get in or get out of the vehicle easily. The step 15 may be drawn out from a vehicle body or stored in the vehicle body. The step 15 is connected to an apparatus for drawing out including a motor, and is operated by the first controller 20.

In certain embodiments, a display 55 receives a signal from the first controller 20 or the second controller 30, and displays a warning to a driver. For example, the display 50 may display the warning to a driver by displaying information on malfunction of the middle door 10 or the step 15, and the interlock of the accelerator pedal 50.

In certain embodiments, the display 55 may include at least one of a liquid crystal display (LCD), a thin film transistor liquid crystal display (TFT LCD), an organic light emitting diode (OLED), a flexible display, a 3D display, and the like.

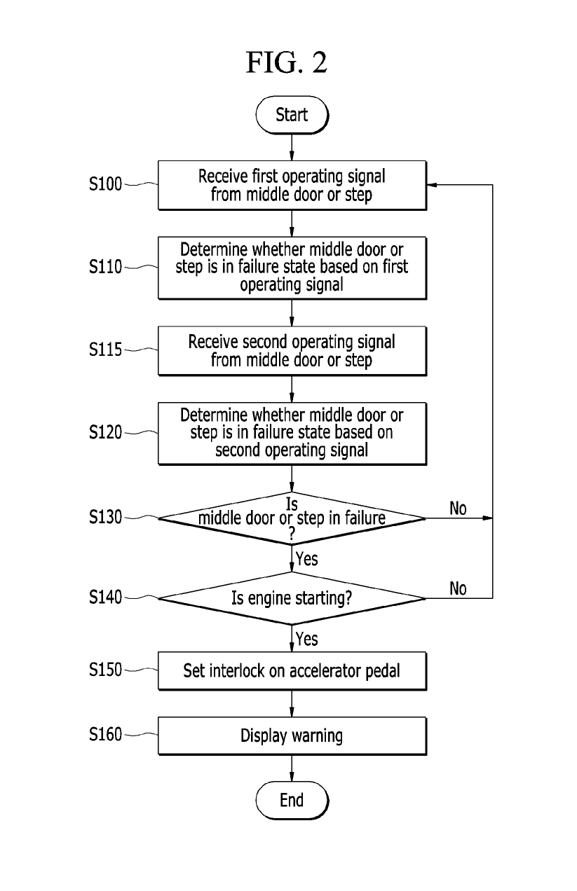

Hereinafter, a malfunction diagnosis method of a middle door or a step for a vehicle according to an exemplary embodiment of the present invention will be described in detail with reference to FIG. 2.

FIG. 2 is a flowchart illustrating a malfunction diagnosis method of a middle door or a step for a vehicle according to an exemplary embodiment of the present invention.

As shown in FIG. 2, a malfunction diagnosis method of a middle door or a step for a vehicle according to an exemplary embodiment of the present invention includes receiving a first operating signal from the middle door 10 or the step 15 of the vehicle at step S100 and receiving a second operating signal from the middle door 10 or the step 15 of the vehicle at step S115.

In certain embodiments, the step of receiving the first operating signal from the middle door 10 or the step 15 of the vehicle may include the step of receiving the second operating signal may include receiving a voltage value which changes in accordance with the operation of the middle door 10 or the step 15 through wiring.

The first operating signal from the middle door 10 or the step 15 of the vehicle is input at the step S100, and the first controller 20 or the second controller 30 determines whether the middle door 10 or the step 15 is in a failure state at step S110 based on the first operating signal.

In certain embodiments, it is determined that the middle door 10 or the step 15 is in the failure state when the data inputted by the CAN communication or the voltage change rate inputted by wiring at the steps S100 and S115 represents the failure state.

In certain embodiments, the data inputted by the CAN communication may include data diagnosing the malfunction, so the first controller 20 or the second controller 30 may directly diagnose malfunction of the middle door 10 or the step 15.

In certain embodiments, the first controller 20 or the second controller 30 compares the voltage change rate inputted by wiring with a predetermined value, and determines that the middle door 10 or the step 15 is in the failure state when the voltage change rate is out of a normal range.

In certain embodiments, the second operating signal from the middle door 10 or the step 15 of the vehicle is input at the step S115, and the first controller 20 or the second controller 30 also determines whether the middle door 10 or the step 15 is in a failure state based on the second operating signal at step S120.

In certain embodiments, the method of diagnosing the middle door 10 or the step 15 by the second controller 30 may be the same as the method by the first controller 20 described above, so the detailed description is not provided.

If both steps S110 and S120 lead to the determination that the middle door 10 or the step 15 is in the failure state at step S130, the first controller 20 or the second controller 30 determines whether an engine is starting at step S140.

In certain embodiments, if either the first controller 20 or the second controller 30, or a single controller that performs step S110 and S120, determines that the middle door 10 or the step 15 is not in the failure state at the step S130, the process is returned to the step S100.

Moreover, in certain embodiments, if the engine is not starting at the step S140, the process is returned to the step S100.

In certain embodiments, when the engine is starting at the step S140, the first controller 20 or the second controller 30 may set an interlock on the accelerator pedal 50 at step S150.

In certain embodiments, the first operating signal of the middle door 10 or the step 15 at the step S100 or the second operating signal at step S115 may be input only if the vehicle is stopped, so the engine starting at the step S140 may mean that an ignition of the vehicle is on.

At this time, the first controller 20 or the second controller 30 may set the interlock on the accelerator pedal 50 in order to prevent starting when the middle door 10 is opened or the step 15 is protruded.

After that, in certain embodiments, the first controller 20 or the second controller 30 may display a warning that vehicle starting is prevented by setting the interlock on the accelerator pedal to a driver through the display 55 at step S160.

As described above, according to an exemplary embodiment of the present invention, robustness and reliability of the malfunction diagnosis can be secured by simultaneously performing malfunction diagnosis in the second controller 30 as well as the first controller 20.

In addition, an interlock on an accelerator pedal is accurately set due to a correct malfunction diagnosis, so an occupant may board the vehicle safely while meeting regulations.

While exemplary embodiments of this invention have been described above, it is to be understood that the invention is not limited to the disclosed embodiments. On the contrary, it is intended to cover various modifications and equivalent arrangements included within the spirit and scope of the appended claims.

What is claimed is:

1. A malfunction diagnosis method of a middle door or a step of a vehicle, the method comprising:
a first receiving step of receiving a first operating signal from the middle door or the step of the vehicle;
a first diagnosis step of diagnosing whether the middle door or the step is in a failure state based on the first operating signal;
a second receiving step of receiving a second operating signal from the middle door or the step of the vehicle;
a second diagnosis step of diagnosing whether the middle door or the step is in a failure state based on the second operating signal;
determining whether an engine is starting if the first and second diagnosis steps indicate that the middle door or the step is in the failure state; and
setting an interlock on an accelerator pedal if it is determined that the engine is starting.

2. The malfunction diagnosis method of claim 1, further comprising
displaying a warning to a driver if the interlock on the accelerator pedal is set.

3. The malfunction diagnosis method of claim 1, wherein
the first operating signal is a voltage value that changes in accordance with the operation of the middle door or the step, and
the second operating signal is data input by CAN communication for determining whether the middle door or the step operates.

4. The malfunction diagnosis method of claim 3, wherein
the first diagnosis step comprises determining that the middle door or the step is in the failure state when the voltage value has a change rate that is out of a normal range, and
the second diagnosis step comprises determining that the middle door or the step is in the failure state when the data inputted by the CAN communication represents the failure state.

5. The malfunction diagnosis method of claim 4, wherein the first receiving and diagnosis steps are performed by a first controller, and the second receiving and diagnosis steps are performed by a second controller.

6. The malfunction diagnosis method of claim 4, wherein the first controller is configured to control the middle door or the step of the vehicle, and the second controller is configured to control the engine.

7. A malfunction diagnosis system in a vehicle, the vehicle comprising an engine, a middle door or a step of the vehicle, and an accelerator pedal comprising an interlock, the system comprising:
one or more controllers configured to perform the following steps:
a first receiving step of receiving a first operating signal from the middle door or the step of the vehicle;
a first diagnosis step of diagnosing whether the middle door or the step is in a failure state based on the first operating signal;
a second receiving step of receiving a second operating signal from the middle door or the step of the vehicle;
a second diagnosis step of diagnosing whether the middle door or the step is in a failure state based on the second operating signal;
determining whether an engine is starting if the first and second diagnosis steps indicate that the middle door or the step is in the failure state; and
setting an interlock on an accelerator pedal if it is determined that the engine is starting.

8. The system of claim 7, further comprising a display,
wherein the one or more controllers are configured to display a warning to a driver if the interlock on the accelerator pedal is set.

9. The system of claim 7, wherein the first operating signal is a voltage value that changes in accordance with the operation of the middle door or the step, and
the second operating signal is data input by CAN communication for determining whether the middle door or the step operates.

10. The system of claim 9, wherein
the one or more controllers include a first controller configured perform the first receiving and diagnosis steps and a second controller configured to perform the second receiving and diagnosis steps.

11. The system of claim 10, wherein the first controller is configured to control the middle door or the step of the vehicle, and the second controller is configured to control the engine.

12. The system of claim 9, wherein the first diagnosis step comprises determining that the middle door or the step is in the failure state when the voltage value has a change rate that is out of a normal range, and
the second diagnosis step comprises determining that the middle door or the step is in the failure state when the data inputted by the CAN communication represents the failure state.

13. The system of claim 7, wherein
the one or more controllers include a first controller configured perform the first receiving and diagnosis steps and a second controller configured to perform the second receiving and diagnosis steps.
